(19) United States
(12) Patent Application Publication
(10) Pub. No.: US 2011/0120990 A1
(43) Pub. Date: May 26, 2011

(54) MICROWAVE OVEN POWER SHARING METHOD AND APPARATUS

(75) Inventor: Mark Heimerdinger, Louisville, KY (US)

(73) Assignee: General Electric Company

(21) Appl. No.: 12/625,606

(22) Filed: Nov. 25, 2009

(51) Int. Cl. H05B 6/68

(52) U.S. Cl. 219/702

(57) ABSTRACT

A microwave oven and methods are presented in which the duty cycle of the current to the primary winding of a transformer in a half-wave voltage doubler feeding the magnetron is controlled according to the current drawn by auxiliary devices in the microwave oven to control the average current consumption of the microwave over time during a heating operation so an associated protection device will not trip.

### BACKGROUND OF THE DISCLOSURE

Microwave ovens use microwave energy to heat articles quicker than conventional convection ovens. Consumer microwave ovens derive power from an external power source, such as 120 V at 60 Hz from a power outlet, through an external protection device, such as a 15 A circuit breaker or 15 A fuse. These protection devices are often actuated based on thermal forces and have a rated maximum current (e.g., 15 A for the protection devices mentioned) correlated to the thermal trip points by current-time curves. Many consumer microwave ovens are designed to use no more than around 15 A averaged over time during a heating process. So-called over-the-range microwave ovens save counter space by being located above the range (cook top) of a stove. Due to that location, auxiliary devices have been added to over-the-range microwave ovens to perform functions unrelated to operation of the microwave cooking space, such as providing ventilation or lighting for the range surface. Unfortunately, these auxiliary devices consume some of the current available to the microwave oven, so when the microwave oven is in a heating process, the average total current consumed by the microwave oven may exceed the maximum current rating of the protection device if auxiliary devices are also in use. Therefore, the current drawn by the microwave oven must be scaled back during a heating process while any of the auxiliary devices are activated. Conventional microwave ovens with auxiliary devices include a tap on the primary winding of a power transformer. When the auxiliary devices are deactivated, the microwave oven uses the normal (high power) tap on the transformer and the microwave uses the maximum current for the heating process. However, when one or more auxiliary devices are activated, the microwave oven uses the low-power tap to alter the turns ratio between the primary winding and the secondary windings, thus the microwave cooking components consume less average current during the heating process. This solution, however, requires the extra tap on the transformer, circuitry associated with the extra winding, relays, and fuses which are not required in microwave ovens without auxiliary devices. Thus, there is a continuing need for improved over-the-range microwave ovens that provide cost-effective current limitation during the heating process while one or more auxiliary devices are activated.

### SUMMARY OF THE DISCLOSURE

The present disclosure provides a microwave oven apparatus and control techniques that may be employed to facilitate operation of a microwave oven during a heating process while one or more auxiliary devices are activated while maintaining the average current drawn by the system below a maximum current rating of an associated protection device.

A microwave oven is disclosed, which includes a housing, an opening, a door, and an interior to hold articles for heating. The microwave oven further includes a user interface which receives an input from a user and produces a user command signal to a controller. A microwave energy source is provided which includes a switch, a half-wave voltage doubler, and a magnetron. The switch either passes or blocks current from an associated AC power source to the primary winding of a transformer of the half-wave voltage doubler which feeds the filament and anode terminals of the magnetron. With power applied to the filaments and anode of the magnetron, the microwave energy source provides microwave energy to heat the articles in the interior of the microwave oven during a heating process. The microwave oven also includes one or more current-consuming auxiliary devices, as well as a controller that determines if one or more of the auxiliary devices are active, and operates the switch according to a duty cycle less than the maximum selectable duty cycle for the operation of the switch when at least one of the auxiliary devices are activated.

A method is provided for heating articles using a microwave oven having auxiliary devices, which includes receiving a heating command indicating a power level from a user, determining a user-requested duty cycle value from a first set of duty cycle values based on the power level indicated by the heating command, and determining if one or more current-consuming auxiliary devices of the microwave oven are activated. If no auxiliary devices are activated, the method involves controlling a heating process of the microwave oven based on the user-requested duty cycle value. If one or more of the auxiliary devices are activated, the method provides for selecting an auxiliary duty cycle value from a set of predetermined duty cycles less than the maximum selectable duty cycle based at least partially on the power level indicated by the heating command, and controlling the heating process of the microwave oven based on the auxiliary duty cycle value.

### BRIEF DESCRIPTION OF THE DRAWINGS

One or more exemplary embodiments are set forth in the following detailed description and the drawings, in which:

FIG. 1 is a diagram illustrating an exemplary microwave oven having a housing and a user interface module;

FIG. 2 is a schematic diagram illustrating further details of the exemplary microwave oven of FIG. 1, including a microwave energy source, a controller, and one or more current-consuming auxiliary devices;

FIG. 3 is a detailed schematic diagram illustrating an exemplary microwave energy source of the exemplary microwave oven of FIGS. 1-2, including a magnetron, a switch, a half-wave voltage doubler having an untapped transformer, a capacitor, and a diode; and

FIG. 4 is a flow chart illustrating an exemplary method of controlling a microwave oven.

### DETAILED DESCRIPTION OF THE PREFERRED EMBODIMENTS

Referring now to the drawings, where like reference numerals are used to refer to like elements throughout, and wherein the various features are not necessarily drawn to scale, the present disclosure relates to microwave ovens and more particularly to over-the-range microwave ovens with auxiliary devices and will be described with particular reference thereto, although the exemplary control techniques described herein may also be used with other microwave ovens with auxiliary devices, and are not limited to the aforementioned application.

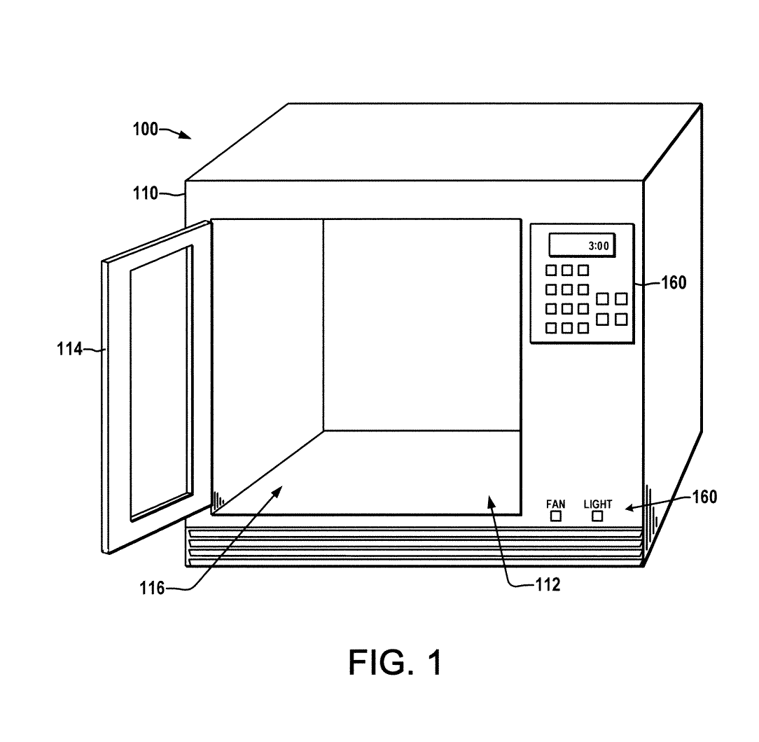

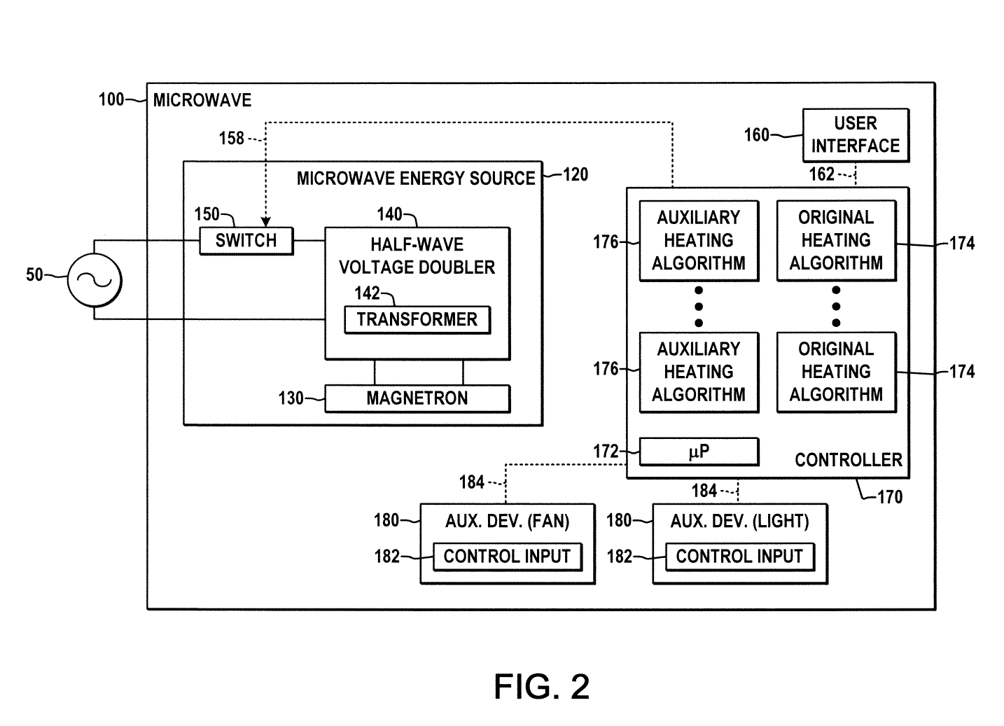

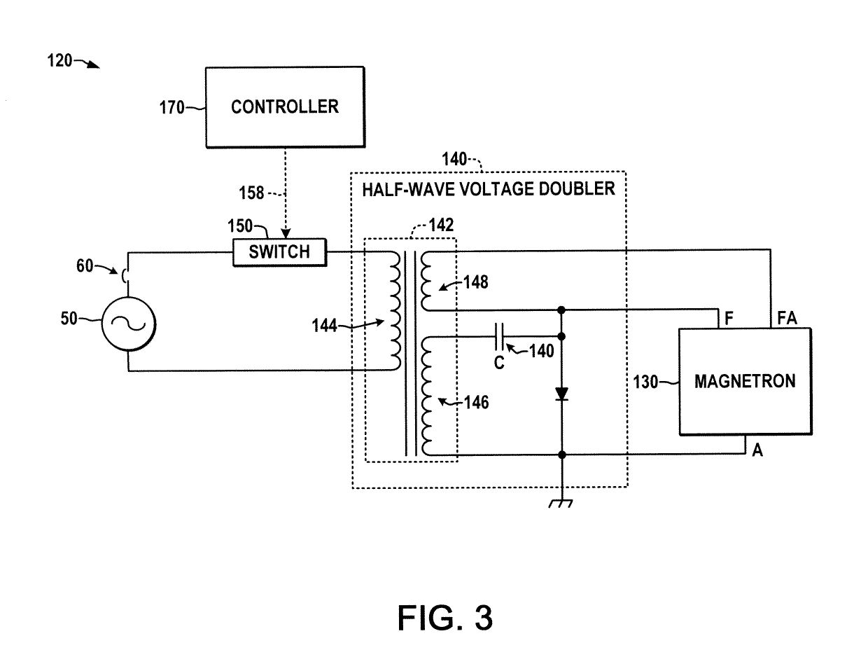

FIGS. 1 and 2 illustrate a microwave oven 100 in which a switch 150 (FIG. 2) selectively passes or blocks current from an associated AC power source 50 to a half-wave voltage doubler 140 of a microwave energy source 120 while one or more auxiliary devices 180 are active to limit the current consumed by the microwave oven 100 during a heating process. The microwave oven 100 is protected by an associated protection device 60 (FIG. 3), such as but not limited to a circuit breaker or a fuse, which limits the amount of current the microwave oven 100 may draw from power source 50.

The microwave oven 100 includes a housing 110, having an oven cavity or interior 112 to hold articles for heating and a door 114 which covers an opening 116 to the interior 112 when closed. FIG. 2 illustrates an exemplary microwave energy source 120 which includes a magnetron 130 that supplies microwave energy to heat the articles stored in the interior 112 of the microwave oven 100 during a heating process. The magnetron 130 receives operating power via a transformer 142 of the half-wave voltage doubler 140, which in turn receives AC power through a switch 150. The operation of the exemplary microwave energy source 120 is described in greater detail in reference to FIG. 3 below.

A user interface 160 is provided to allow a user to supply commands for the operation of the microwave oven 100 and auxiliary devices 180. In some embodiments, the user interface 160 includes a touchpad, one or more knobs, one or more buttons, a display such as abut not limited to a light emitting diode (LED) display or a liquid crystal display (LCD), or any combination thereof. The user interface 160 translates the user supplied command into a user command signal 162 for transmission to a controller 170. Controller 170 controls energization of the microwave energy source 120. The user command signal 162 includes information such as but not limited to a request for the controller 170 to commence a heating process, the amount of time the controller 170 should keep the microwave oven 100 in the heating process, the power level at which the controller 170 should operate the microwave energy source 120 during the heating process, a request for a preprogrammed heating algorithm 174, a request to activate or control a current-consuming auxiliary device 180, or any combination thereof. In the exemplary controller 170, when the controller 170 receives the user command signal 162, a microprocessor 172 decodes the signal 162 and controls energization of the microwave energy source according to the user command (including controlling the switch 150). In certain embodiments, the controller 170 may be implemented by any suitable form of hardware, processor-executed software, firmware, programmable logic, or combination thereof, and may be a unitary control component or may be implemented in a distributed fashion.

The exemplary microwave oven 100 also includes one or more current-consuming auxiliary devices 180 which, when activated, also receive power from the AC power supply 50 through the protection device 60. As used herein, a current-consuming auxiliary device 180 is defined as an electric or electronic device that is controlled independently of the heating process such as, but not limited to, a vent fan for providing ventilation of a range, a range light for providing light to a range, or both. An auxiliary device 180 does not include components or devices that are part of the microwave's heating process, such as the microwave energy source 120, the controller 170, an interior light, an interior blower, a motor for rotating a plate within the interior during a heating process, the user interface 160 including a display, or any combination thereof. In certain embodiments, the auxiliary device 180 includes a control input 182 that receives an auxiliary device control signal 184 from the controller 170. In the exemplary microwave oven 100, when the user supplies a request to control an auxiliary device 180, the controller 170 decodes the user command signal 162 and produces the auxiliary device control signal 184 to control the auxiliary device 180. For example, if the user requests a “low setting” on the vent fan 180, the controller 170 decodes the user command signal 162 and generates an auxiliary device control signal 184 for the vent fan 180 including an activation command and a low intensity setting (e.g., low fan speed). In one embodiment, the signal 184 is as simple as a dedicated pulse width modulated (PWM) signal, while in other embodiments the signal 184 may be more complicated such as but not limited to using a bus structure connecting one or more of the devices (auxiliary 180, non-auxiliary 120, 160 and 170, or combinations thereof) attached to the controller 170.

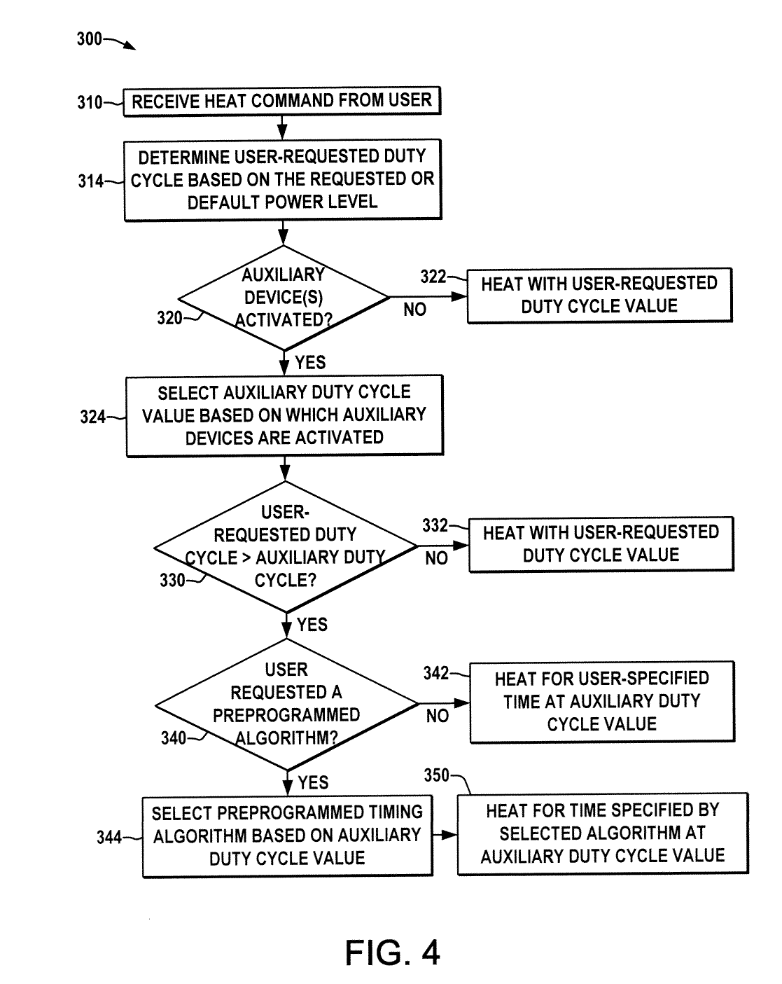

In certain embodiments, when the user supplies a request for a heating process, the controller 170 decodes the information about the power level and heating time from the user command signal 162. In some embodiments, if no power level information is supplied by the user, the controller 170 will default to a maximum power level. The controller 170 translates the power level requested by the user (explicit or default) into a duty cycle value and determines if at least one auxiliary device 180 is activated. If no auxiliary devices 180 are activated, the controller 170 generates a switch control signal 158 that uses the duty cycle value at which the switch 150 passes or blocks current from the associated power source 50 through the associated protection device 60 to the primary winding 144 (FIG. 3) of the transformer 142 in the half-wave voltage doubler 140. The details of how the duty cycle of a current is tied to the average current consumed during the heating process are discussed in greater detail in reference to FIG. 3 below. If one or more auxiliary devices 180 are activated, the controller 170 determines a new lower duty cycle value (an auxiliary duty cycle value, explained in detail in reference to FIG. 4 below) such that the average of the current drawn by the entire microwave oven 100 (the auxiliary 180 and non-auxiliary devices 120, 160 and 170 combined) is less than the maximum current rating of the associated protection device 60, whereby even a maximum user-selected power level will result in an auxiliary duty cycle less than the duty cycle associated with the maximum power level. For example, if the duty cycle associated with the maximum power level is a 100% on time, then the auxiliary duty cycle will have a non-zero off time.

In some embodiments, the period of the duty cycle is 30 seconds, wherein a 70% duty cycle has an “on time” of 21 seconds and an “off time” of 9 seconds. In certain embodiments, a power level less than the maximum power output of the microwave oven 100 is obtained by controlling the duty cycle of the current from the associated AC power source 50 to the primary winding 144 (FIG. 3) of the transformer 142 in the half-wave voltage doubler 140.

Several methods are contemplated to determine the auxiliary duty cycle at which to operate the switch 150. In a first set of embodiments, the auxiliary duty cycle value is one predetermined value (or a set of one value) determined by subtracting the total maximum current drawn by all the auxiliary devices 180 from the maximum current rating of a typical associated protection device 60, then translating the resulting current into a duty cycle value. For example, in certain embodiments, the exemplary microwave oven 100 is used in a consumer application connected to 120 VAC through a 15 A circuit breaker or fuse. If the vent fan 180 draws a maximum current of 1 A and the range light 180 draws a maximum current of 0.5 A, then the total maximum current draw of the auxiliary devices 180 is 1.5 A. Subtracting 1.5 A from 15 A gives 13.5 A to operate the microwave oven 100 during the heating process without tripping the associated protection device 60. Hypothetically, if the microwave oven 100 draws 13.5 A at an 85% duty cycle, then the new duty cycle value is 85%. In this embodiment, the controller 170 uses 85% as the new duty cycle value whenever any of the auxiliary devices 180 are activated, regardless of the number of auxiliary devices 180 activated and at which settings.

In a second set of embodiments, the auxiliary duty cycle value is determined from a set of more than one value using a similar formula as the one above. The number of values in the set may be determined by the number of auxiliary devices 180 and the number of settings for those auxiliary devices 180. For the exemplary microwave oven 100, the vent fan 180 has three settings: deactivated, low, and high, and the range light 180 has two settings: deactivated and activated. Therefore, the set of duty cycle values in the exemplary microwave oven 100 has a maximum of five values: three (settings in the vent fan 180) times two (settings in the range light 180) is six, then subtract one because if both are deactivated there is no need to determine a new duty cycle value, resulting in five values. The values for each duty cycle value in the set are determined using the formula above. Some embodiments use all the values available, while other embodiments only use a partial set.

In a third set of embodiments, the auxiliary duty cycle value is determined dynamically from up to an infinite set of values. The controller 170 determines the duty cycle value dynamically by monitoring how much current the auxiliary devices 180 are actually consuming at that time, as opposed to the maximums used in the methods above, and subtracting that amperage from the maximum current rating of the associated protection device 60 and implements a duty cycle equal to the ratio of this difference to the maximum rated current or approximately so. The above examples are indicative of some, but not all, of the methods available to determine the new duty cycle at which to operate the switch 150.

FIG. 3 illustrates one suitable embodiment of a microwave energy source 120 in the microwave oven 100. The magnetron 130 supplies microwave energy when an AC voltage is across the filament at F and FA and a high DC voltage is across F and A. The half-wave voltage doubler 140 supplies these voltages. When an AC current flows through the primary winding 144 of the transformer 142, an induced voltage is present across both the untapped first secondary winding 146 and the second secondary winding 148. The second secondary winding 148 has a turns ratio in relation to the primary winding 144 such that a 3.3 VAC voltage is present on the second secondary winding 148, which feeds the filament through terminals F and FA. The first secondary winding 146 has a constant turns ratio in relation to the primary winding 144 such that 2 kVAC is present on the first secondary winding 146. After several cycles, the capacitor C140 is charged to 2 kVDC and the entire 2 kVAC across the first secondary winding 146 is superimposed on top of the 2 kVDC on the capacitor C 140, doubling the voltage. The diode D140 clamps the positive peaks of the doubled voltage, creating a −4 kVDC during the negative half cycles of the voltage across the first secondary winding 146, which provides the high DC voltage (−4 kVDC) across F and A. Thus, the frequency of the −4 kVDC is equal to the frequency of the 3.3 VAC, which is equal to the frequency of the AC voltage across the primary winding 144 of the transformer 142. Therefore, the voltages induced on the first secondary winding 146 and the second secondary winding 148 are present only when current is flowing through the primary winding 144 of the transformer 142. The switch 150 selectively passes or blocks current from the AC power source 50 through the protection device 60 to the primary winding 144 of the transformer 142, thus when the controller 170 controls the switch 150, the controller 170 essentially controls the magnetron 130. The switch 150 may be implemented by any suitable means of hardware including but not limited to a TRIAC, relay, or other semiconductor-based or electro-magnetic type switching devices, or any combination thereof.

The inventor has appreciated that most circuit protection devices 60 correlate a temperature value to a current value, thus a 15 A circuit breaker does not trip when the instantaneous current through it is 15 A, but does trip when the temperature of the circuit breaker reaches a level indicative of a 15 A current averaged over time. Thus, the instantaneous current through the circuit breaker 60 is not what trips the breaker 60, but the average current over time which is translated into temperature is what trips a breaker 60. Therefore, the instantaneous current drawn by the exemplary microwave oven 100 may reach over the maximum current rating of the associated protection device 60 and not trip the protection device 60 unless the current draw is allowed to remain over the maximum current rating for an extended period of time. By controlling the duty cycle of the current passed from the associated AC power source 50 through the associated protection device 60 to the primary winding 144 of the transformer 142, the instantaneous current drawn by the exemplary microwave oven 100 during a heating process while one or more auxiliary devices 180 are active may exceed the maximum current rating of the protection device 60, but the average current over time will generally not trip the protection device 60. The off time of the duty cycle allows the protection device 60 to cool down so it does not trip. The more the instantaneous current is above the maximum current rating, the more off time in the duty cycle is required to allow the protection device 60 to cool down. The average current drawn by the exemplary microwave oven 100 is maintained below the maximum current rating of the protection device 60 by the controller 170 as described above in relation to FIGS. 1-2.

FIG. 4 is a flow diagram illustrating an exemplary method 300 of operating the exemplary microwave oven 100 for a heating process while auxiliary devices are activated. While the method 300 is illustrated and described below in the form of a series of acts or events, it will be appreciated that the various methods of the disclosure are not limited by the illustrated ordering of such acts or events. In this regard, except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined. The illustrated methods and other methods of the disclosure may be implemented in hardware, processor-executed software, or combinations thereof, such as in the exemplary controller 170, in order to provide the supplemental heating aspects illustrated and described herein.

At 310 in FIG. 4, the controller 170 receives a heating process command from a user via the user interface 160 and the user command signal 162. The user command signal 162 includes, among other things, the time the microwave oven should remain in the heating process, the power level, or both. The user specifies the time by expressly entering the time in the user interface 160, selecting a preprogrammed heating algorithm 174 (e.g. the POPCORN button), or other ways. The power level may be requested by the user, inter alia, through express request, through a preprogrammed heating algorithm selection 174, by default, or any combination thereof. As described above in relation to FIGS. 1-2, the controller 170 determines a user-requested duty cycle value at 314 from a first set of duty cycle values based on the power level requested by the user, such as from a lookup table stored in the controller 170. At 320, the controller 170 determines if any auxiliary devices 180 are activated. If no auxiliary devices 180 are activated, the controller 170 controls the microwave oven 100 to perform a heating process for the time specified by the user with the user-requested duty cycle value at 322.

If one or more auxiliary devices 180 are activated, the controller 170 selects an auxiliary duty cycle value from a second set of duty cycle values at 324. This second set of duty cycle values does not include any values that are included in the first set of duty cycle values. At 330, the controller 170 compares the user-requested duty cycle value and the auxiliary duty cycle value. In some embodiments, if the user-requested duty cycle value is less than the auxiliary duty cycle value, then the controller 170 controls the microwave oven 100 to perform a heating process for the time specified by the user at with the user-requested duty cycle value at 332.

At 340, the controller 170 determines if the user has selected a preprogrammed heating algorithm 174. If the user has not selected a preprogrammed heating algorithm 174, then the controller 170 controls the microwave oven 100 to perform a heating process for the time specified by the user at with the auxiliary duty cycle value at 342. If the user has selected a preprogrammed heating algorithm 174, the controller 170 selects an auxiliary preprogrammed heating algorithm 176 corresponding to the original heating algorithm 174, yet modified to compensate for the duty cycle at 344. At 350, the controller 170 controls the microwave oven 100 to perform a heating process for the time specified by the auxiliary preprogrammed heating algorithm 176 at with the auxiliary duty cycle value.

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”. The invention has been described with reference to the preferred embodiments. Obviously, modifications and alterations will occur to others upon reading and understanding the preceding detailed description. It is intended that the invention be construed as including all such modifications and alterations.

The following is claimed:

1. A microwave oven comprising:
a housing including an interior, an opening, and a door;
a user interface operative to generate a user command signal based at least in part on a user heat command input;
at least one current-consuming auxiliary device including a control input operative to receive an auxiliary device control signal;
a microwave energy source operative to heat food items in the interior, the microwave energy source including:
a magnetron comprising filament terminals and an anode terminal,
a half-wave voltage doubler comprising a transformer including a primary winding, a first secondary winding operatively coupled to the magnetron, and a second secondary winding operatively coupled with the filament terminals of the magnetron, and
a switch operatively coupled between an associated AC power source and the primary winding of the transformer of the half-wave voltage doubler, the switch operative according to a switch control signal in a first state to selectively allow current to flow between the associated AC power source and the transformer of the half-wave voltage doubler and in a second state to prevent current flow between the associated AC power source and the transformer of the half-wave voltage doubler; and
a controller coupled with the user interface and operative to produce the switch control signal to control a heating process of the microwave oven at a duty cycle less than the maximum duty cycle when at least one auxiliary device is activated and the user command signal indicates that a maximum power output of the microwave oven is requested by the user.

2. The microwave oven of claim 1, wherein the microwave oven is an over-the-range microwave oven having a fan auxiliary device and a range light auxiliary device.

3. The microwave oven of claim 1, wherein the at least one auxiliary devices is a vent fan.

4. The microwave oven of claim 1, wherein the at least one auxiliary devices is a range light.

5. The microwave oven of claim 1, wherein the controller is operative to produce the switch control signal to control a heating process of the microwave oven at a duty cycle having a non-zero off-time when at least one auxiliary device is activated and the user command signal indicates that a maximum power output of the microwave oven is requested by the user.

6. The microwave oven of claim 1, wherein the user interface provides the user command signal including a power level at which the user desires the microwave energy source to be operated during a heating process;
wherein the controller determines a user-requested duty cycle value from a first set of duty cycle values based on the power level included in the user command signal;
wherein if no auxiliary devices are activated, the controller produces the switch control signal controls the heating process of the microwave oven at the user-requested duty cycle value;
wherein if one or more auxiliary devices are activated, the controller selects an auxiliary duty cycle value less than the user requested duty cycle value from a second set of duty cycle values based on the power level included in the user command signal and controls the heating process of the microwave oven at the selected auxiliary duty cycle value.

7. An over-the-range microwave oven comprising:
a housing including an interior, an opening, and a door;
a user interface operative to generate a user command signal based at least in part on an input from a user;
at least one current-consuming auxiliary device including a control input operative to receive an auxiliary device control signal;
a microwave energy source operatively coupled to the interior, the microwave energy source including:
a magnetron including filament terminals and an anode terminal, and
a half-wave voltage doubler comprising a transformer including a primary winding and a secondary winding operatively coupled between a filament terminal and the secondary winding defining a turns-ratio that remains constant throughout operation of the microwave oven; and
a controller operative to control operation of the microwave energy source to control a heating process of the microwave oven.

8. The over-the-range microwave oven of claim 7, wherein the microwave energy source further comprises a switch operatively coupled between an associated AC power source and the primary winding of the transformer of the half-wave voltage doubler, the switch operative according to a switch control signal in a first state to selectively allow current to flow between the associated AC power source and the transformer of the half-wave voltage doubler and in a second state to prevent current flow between the associated AC power source and the transformer of the half-wave voltage doubler, and wherein the controller is operative to determine a duty cycle value based at least partially on the user command signal and on whether at least one auxiliary device is activated and to produce the switch control signal to control a heating process of the microwave oven at the determined duty cycle.

9. The over-the-range microwave oven of claim 8, wherein the controller is operative to produce the switch control signal to control the heating process of the microwave oven at a duty cycle less than the maximum power duty cycle when at least one auxiliary device is activated and the user command signal indicates that a maximum power output of the microwave oven is requested by the user.

10. The over-the-range microwave oven of claim 8, wherein the user interface provides the user command signal including a power level at which the user desires the microwave energy source to be operated during a heating process;
wherein the controller determines a user-requested duty cycle value from a first set of duty cycle values including a maximum duty cycle, based on the power level included in the user command signal;
wherein if no auxiliary devices are activated, the controller produces the switch control signal controls the heating process of the microwave oven at the user-requested duty cycle value;
wherein if one or more auxiliary devices are activated, the controller selects an auxiliary duty cycle value less than the maximum duty cycle from a second set of duty cycle values based on the power level included in the user command signal and controls the heating process of the microwave oven at the selected auxiliary duty cycle value.

11. The over-the-range microwave oven of claim 8, wherein the at least one auxiliary devices is a vent fan.

12. The over-the-range microwave oven of claim 8, wherein the at least one auxiliary devices is a range light.

13. A method of heating articles using a microwave oven comprising:
receiving a heating command indicating a power level from a user;
determining a user-requested duty cycle value from a first set of duty cycle values including a maximum duty cycle, based on the power level indicated by the heating command;
determining if one or more current-consuming auxiliary devices of the microwave oven are activated;
if no auxiliary devices are activated, controlling a heating process of the microwave oven based on the user-requested duty cycle value;
if at least one auxiliary device is activated, selecting an auxiliary duty cycle value from a second set of predetermined duty cycles less than the maximum duty cycle, based at least partially on the power level indicated by the heating command, and controlling the heating process of the microwave oven based on the auxiliary duty cycle value.

14. The method of claim 13, wherein determining the user-requested duty cycle value is based at least in part on a default power level.

15. The method of claim 13, wherein determining the user-requested duty cycle value is based at least in part on a user-selected pre-programmed heating algorithm.

16. A microwave oven comprising:
a housing including an oven cavity for receiving a load to be heated;
a microwave energy source operative to heat the load;
a user interface operative to generate a user command signal based at least in part on a user heat command input;
at least one selectively activated current-consuming auxiliary device;
a controller coupled with the user interface and the microwave energy source for controlling the output power level of the microwave energy source and operative to determine if the auxiliary device is activated and to implement a power level less than the maximum power level when the user command signal calls for the maximum power level if at least one auxiliary device is activated.

17. The microwave oven of claim 16 wherein the auxiliary power level is a predetermined power level.

18. The microwave oven of claim 16 wherein the auxiliary power level is determined by the controller as a function of the current drawn by the auxiliary device.

19. The microwave oven of claim 16, wherein the user command signal represents a power level at which the user desires the microwave energy source to be operated during a heating process;
wherein the controller determines a user-requested duty cycle value from a first set of duty cycle values based on the power level represented by the user command signal;
wherein if no auxiliary devices are activated, the controller operates the microwave energy source at the user-requested duty cycle value;
wherein if one or more auxiliary devices are activated, and the user-requested duty cycle value is the maximum duty cycle, the controller selects an auxiliary duty cycle value less than the maximum duty cycle from a second set of duty cycle values and controls the heating process of the microwave oven at the selected auxiliary duty cycle value.

20. The microwave oven of claim 19 wherein the auxiliary duty cycle value is a predetermined value.

21. The microwave oven of claim 19 wherein the auxiliary duty cycle is determined by the controller as a function of the current drawn by the auxiliary device.
